(19) United States
(12) Patent Application Publication
(10) Pub. No.: US 2021/0271217 A1
(43) Pub. Date: Sep. 2, 2021

(54) Using Real Time Data For Facilities Control Systems

(71) Applicants: David Greschler, Kirkland, WA (US); Jonah Friedl, Kirkland, WA (US)

(72) Inventors: David Greschler, Kirkland, WA (US); Jonah Friedl, Kirkland, WA (US)

(21) Appl. No.: 17/230,338

(22) Filed: Apr. 14, 2021

Related U.S. Application Data
(63) Continuation-in-part of application No. 16/295,951, filed on Mar. 7, 2019.
(60) Provisional application No. 63/009,971, filed on Apr. 14, 2020.

(51) Int. Cl. G05B 19/042; G06F 16/23; G06F 16/245

(52) U.S. Cl. CPC G05B 19/042; G05B 2219/2614; G06F 16/245; G06F 16/2379

(57) ABSTRACT

Equipment and ways to control and manage an environment are described. In one example, data associated with the environment is obtained by at least one sensing device and transmitted to a controller. The controller may control or manage a system such as a lighting system, HVAC system, or security system.

### TECHNICAL FIELD

The present subject matter relates to managing, operating, or controlling systems environments.

### BACKGROUND

Typically, managing systems environments entailed human observation, often through the use of electronic equipment. However, data obtained under such circumstances have traditionally been limited and have proven to be inadequate for efficient and precise control of operating and control systems being monitored. In addition, it has often been difficult efficiently obtaining or transmitting sufficient control data in a comprehensible manner and format for timely and beneficial control of such systems.

Building operations generate 39% of greenhouse gas emissions. Over 50% of this comes from heating, ventilation, and air conditioning (HVAC) systems. And up to 23% of HVAC is wasted in unoccupied spaces.

It is desirable to provide a method and system for obtaining data for efficient and effective control of systems environments.

### SUMMARY

Systems and techniques are described for obtaining data and controlling or managing an environment based on the data. Computer vision or machine learning may be used to measure human activity and environmental information, for example, but not limited to, counting the number of people in a space, the time it takes to go from one location to another, ambient light, personalization of temperature, lighting, objects in a room, recognizing a unique individual, conditions of a room, outside conditions and objects, and access) to provide data to control facilities' building controls/systems, including but not limited to heating, ventilation and air conditioning (HVAC), lighting, elevators, escalators, fire safety, social distancing, space planning, resource planning, access, security, and enabling enhanced services. All human activity and environmental information may be captured without any action by the humans engaged in the activity, and may be able to control facilities control systems based on the data collected in real-time. Sensors using computer vision are placed in facilities to capture all types of human activity, such as the presence and number of people in a location, journeys through the built environment, demographics of the humans such as age, gender, sentiment, and other relevant details.

The data captured may be processed on the sensor (known as Edge Computing) or sent to a storage and processing system (server or cloud storage) for processing using a combination of image, video, audio, object detection, facial recognition, or other machine learning models to extract relevant information including but not limited to, the number of humans, number of objects, timing of each human remaining in the area covered by the sensor, the age, gender, sentiment and other characteristics of the humans. This combined data is sent, either directly from the sensor or via the storage and processing system, to controls that directly control facilities controls/systems, including, but not limited to, controllers that control ventilation and air conditioning (HVAC), lighting, elevators, escalators, fire safety, social distancing, space planning, resource planning, access, security, and enhanced services. In addition, this data is also analyzed to provide reports to employees, contractors, managers, owners, vendors, and other roles within and outside companies with built environments in order to gain insights into the usage of the facilities controls/systems, and provide reports, prove compliance and mitigate risks. The data is also processed by algorithms that provide real-time suggestions and automated actions to improve and correct the performance of the facility's controls/systems.

### BRIEF DESCRIPTION OF THE DRAWINGS

FIG. 1 illustrates an overview of a system and method for controlling a system based on data received by a sensing device.

FIG. 2 illustrates an example of a controller receiving data from a plurality of sensing devices.

FIG. 3 illustrates an example of sensing devices situated at varying positions within an environment.

FIG. 4 illustrates an example of a plurality of sensing devices receiving data of individuals within an environment

FIG. 5 illustrates an example of a sensing device for receiving data pertaining to an environment.

FIG. 6 illustrates an example of a controller controlling an HVAC system based on data received from a sensing device.

FIG. 7 illustrates an example of a controller controlling a lighting system based on data received from a sensing device.

FIG. 8 illustrates an example of a controller controlling an enhanced environmental system based on data received from a sensing device.

FIG. 9 illustrates an example of a controller controlling an entry system based on data received from a sensing device.

FIG. 10 illustrates an example of a controller controlling a positioning system based on data received from a sensing device.

FIG. 11 illustrates an example of a controller controlling an emergency alert system based on data received from a sensing device.

FIG. 12 illustrates an example of a controller controlling a use monitoring system based on data received from a sensing device.

FIG. 13 illustrates an example of a controller controlling a customer data system based on data received from a sensing device.

FIG. 14 illustrates an example of a controller controlling an environmental system based on data received from a sensing device.

FIG. 15 illustrates a person in a position where multiple cameras may sense them.

### DETAILED DESCRIPTION

In the following detailed description, specific details are set forth by way of examples. However, it should be apparent to those skilled in the art that the present disclosure is not so limited and that the present disclosure includes modifications to the specific examples described herein without departing from the spirit and scope of the invention.

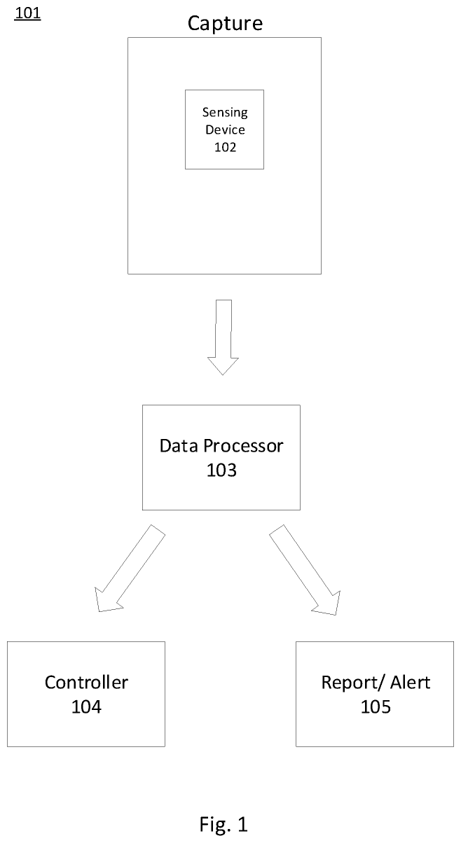

Examples of systems and techniques are described herein for obtaining information and data for effective control of systems environments. FIG. 1 illustrates an example of Control System 101. In this example, data may be collected from an environment and processed, stored, transmitted, or reported. Sensing Device 102 may be used to collect such data, and may be, for example, a camera, a microphone, a seismometer, a mobile device, floor tiles with pressure sensors, or any device with data collecting capabilities. The data may include any type of data including, but not limited to, image, video, sound, or any descriptive data such as date, time, location, or an identifier of an individual, object, or a sensing device. The data may also include data available from the web, for example, traffic, current weather, or weather forecasts.

In one example, information pertaining to occupants in a space may be detected or collected by Sensing Device 102. This data may include, for example, the number of occupants in the room, the relative orientation of the occupants, facial recognition or unique face match data, demographic information such as age, gender, or information on movement or behavior of the occupant(s) in the space.

Sensing Device 102 may further compile data, including any inferred data, or may transmit the collected data to a remote location or remote device for compilation. For example, Sensing Device 102 may transmit the data to a computer or server for further processing. The data may further be stored in a database (at the sensing device or at a remote location) or on a server or cloud. Data Processor 103 may combine data from Sensing Device 102 with data from other sensors or other sources, including, for example, databases or sources on the world wide web.

As non-limiting examples, the data may be transmitted to Controller 104, and Controller 104 may control lighting or other aspects of an associated environment based on the data. In addition to or alternatively, the data may be processed and used to build analytics Reports 105 or real-time suggestions for management of control systems, such as but not limited to lighting systems, HVAC systems, mobility systems, etc.

In one example, an environment may include a space containing at least one component. The at least one component may include, for example, people or objects in the space. Data from the components in the space may be obtained or collected by a variety of mechanisms. For example, at least one Sensing Device 102 may be positioned within a space or outside but within the vicinity of a space that may collect desired data from the components (or people or objects, for example) in a space. As described, Sensing Device 102 may include, for example, a video camera, a camera that obtains still images, a sound recording device, or any device or apparatus for collecting data pertaining to objects in a space.

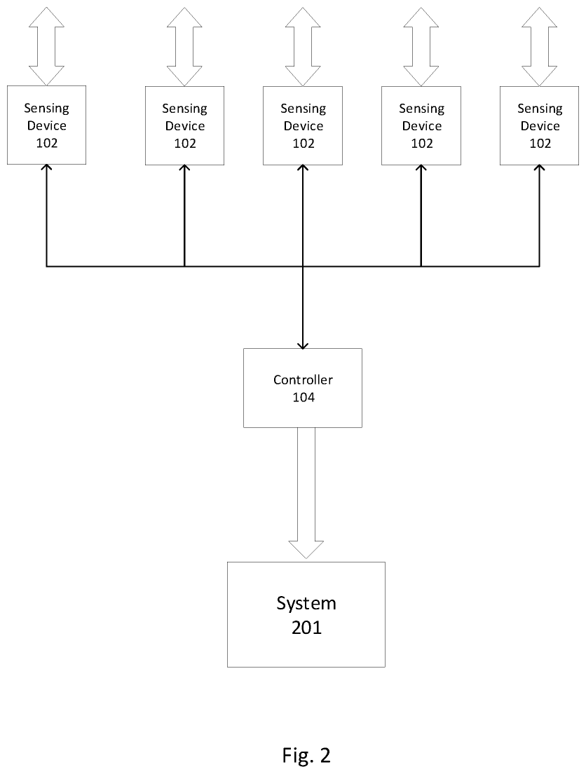

FIG. 2 illustrates one example in which Sensing Device 102 positioned in the vicinity of a space containing people and objects may collect data pertaining to any of the people or objects. In this example, a plurality of Sensing Devices 102 is used such that the relative positioning of Sensing Devices 102 provides additional data of the relative positioning and actions of the individuals or people within the space. One of skill in the art would understand that any number of Sensing Devices 102 may be used to collect data pertaining to any number of people or objects in the environment or space. For example, the relative positioning of two or more people may be accurately ascertained by data from multiple views of the two or more people in the space. For example, the distance between two people in a space may be accurately obtained through the use of multiple views from the at least one sensing device.

Different data may be obtained by Sensing Device 102 and the data obtained may be used for the further management of various Control Systems 201.

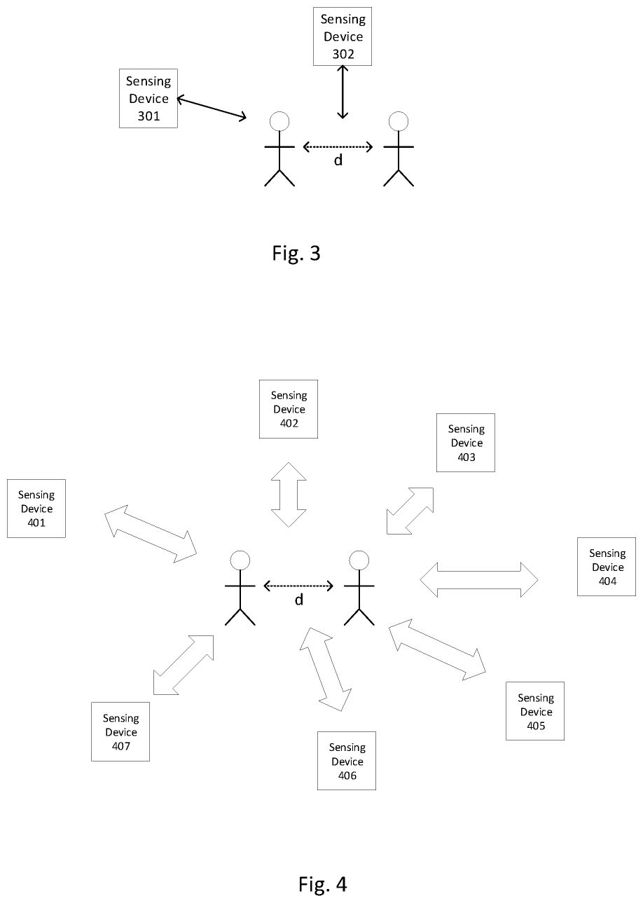

FIG. 3 illustrates an example of obtaining more than one type of data pertaining to individuals or components within a space or Control System 201. In this example, Sensing Device 301 may collect data pertaining to two individuals within a space. The data collected by Sensing Device 301 may include, for example, data indicating that there are two individuals within the space under observation. Sensing Device 302 may further collect different data pertaining to the two individuals within the space. In this example, Sensing Device 302 may collect data indicating that there are two individuals within the space and that the two individuals identified are located a certain distance apart (distance d in this example). Any number of sensing devices may be used and may be positioned in any relative orientation.

As another example, Sensing Devices 301, 302 may respond quickly if the two individuals leave the room and may trigger a reduction or other ventilation, cooling, heating, or lighting adjustment.

FIG. 4 illustrates an example in which sensing devices are situated at different locations around observed individuals within an environment or space. In this example, seven sensing devices are illustrated arranged around the periphery of the space; however, any number of sensing devices in any relative positions may be used. As FIG. 4 illustrates in this example, sensing devices detect the presence of two individuals within the space. Each sensing device may determine a distance d between the two individuals; however, the distance d appears to be different for each of the sensing devices because of the difference in relative positioning between each of the sensing devices and the individuals being observed. In this example, the perceived distance between the individuals determined by Sensing Device 401 may be shorter than the perceived distance between the individuals determined by Sensing Device 402, at least because Sensing Device 402 observes the individuals from a point that is perpendicular to the individuals, but Sensing Device 401 observes the individuals from a point that observes the individuals from a different angle.

Similarly, values for the distance between the individuals within the space or environment obtained from Sensing Devices 403-407 may be different from each other and from both Sensing Device 401 and Sensing Device 402. The value of distance d from Sensing Device 406 may be similar to that obtained from Sensing Device 402 because Sensing Device 406, in this example, is situated in a similar point with respect to the individuals as Sensing Device 402. In addition, values of distance d from each of additional Sensing Devices 401, 403-407 may be lower than the value obtained from Sensing Device 402. In this example, the maximum value of distance d as observed by Sensing Device 402 may be determined to be the most accurate measurement of distance d between the individuals because this observed value of distance d may be collected from a point that may provide the most accurate value for the distance between the individuals.

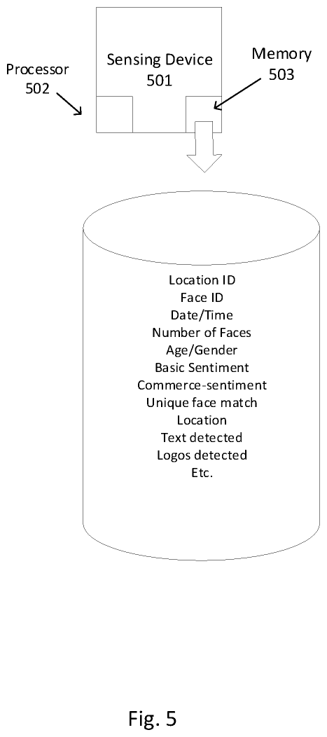

FIG. 5 illustrates an example of Sensing Device 501 for collecting data from an environment. Sensing Device 501, in this example, may include Processor 502 for processing further information of the data obtained from the environment and may also include Memory 503 for storing data. For example, as FIG. 5 illustrates, Sensing Device 501, in this example, may specify the time or date that the data was obtained. Sensing Device 501 may also include, for example, facial recognition capability such that the sensing device may identify at least one individual within the space or environment and may further provide an identifier associated with the specific individual identified. Alternatively, Sensing Device 501 may search a database of identifiers and may match the identified individual identifier to identify the individual observed. Additional information may be provided or obtained by Sensing Device 501, such as, but not limited to, the name, age, gender, or any relevant or desired information associated with the identified individual(s). Alternatively, any data processing functions may be located remotely from Sensing Device 501, such as, for example, on a server or in the cloud.

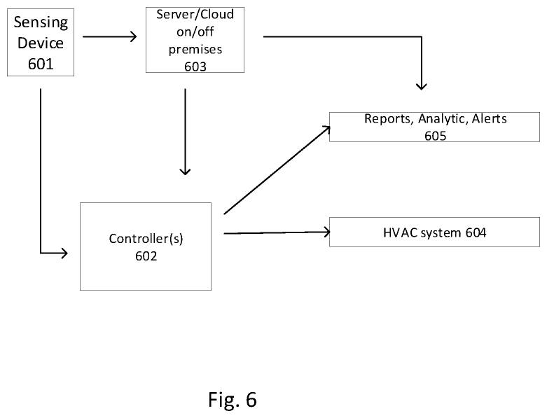

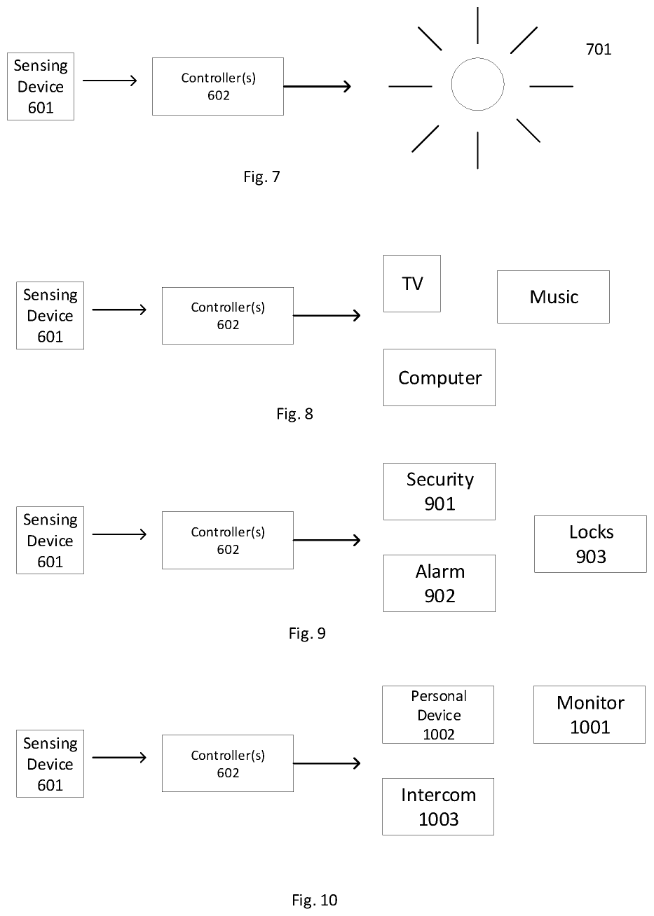

FIG. 6 illustrates an example in which collected data may be stored, used to control an environment, or may be transmitted to a remote location. The data may be stored on Server 603, which may be local or at a remote location, or it may be used to control the environment. In this example, data may be collected or captured from Sensing Device 601, such as, but not limited to, a camera, a phone, or a tablet. The data may further be transmitted to at least one Controller 602 for controlling the environment. As one example, the environment may include a Heating, Ventilation, and Air Conditioning (HVAC) System 604, as depicted in FIG. 7. In this example, data, such as a number or density of people in an environment, may be obtained by at least one Sensing Device 601 in the environment. The data obtained by Sensing Device 601 may be transmitted to a controller 602, which receives the data and controls HVAC System 604 associated with the environment based on the data received from Sensing Device 601. As one non-limiting example, Sensing Device 601 may obtain data pertaining to a size of a room or the number of people within the room and may transmit the data to Controller 602. Based on the number of people in the room relative to the size of the room, Controller 602 may transmit one or more control signals to HVAC System 604 associated with the room or environment such that HVAC System 604 may modify the environment within the room. For example, if the number of people is determined to be high with respect to the size of the room, Controller 602 may modify air flow and temperature of the air provided to the room to maintain a desired temperature within the room. Any number or type of HVAC components may be controlled based on data obtained and transmitted by the at least one sensing device, including, but not limited to, a furnace, air conditioner, fan, dehumidifier, humidifier, air purifier, or fan, to name a few. In addition, Report 605 may be generated by the system, which may include analytics pertaining to the functioning of the environment or alerts or warnings of various conditions. Such reports may be displayed on a display or may be printed.

In another example, as illustrated in FIG. 7, Sensing Device 601 may obtain data indicating that at least one person is present within a room. Sensing Device 601 may transmit the data to Controller 602. Based on the data transmitted from Sensing Device 601, Controller 602 may transmit one or more control signals to Lighting System 701 associated with the room such that at least one light associated with the room may turn on. Conversely, Sensing Device 601 may obtain data indicating that no person is detected within the room. In this example, Controller 602 may control the Lighting System 701 to turn off lights within the room based on this data. A threshold value may be established, for example, number of people in the room, that may be used to determine whether Controller 602 should transmit the control signals.

In yet another example, as illustrated in FIG. 8, Controller 602 may control a system to provide enhanced environmental experiences based on the data obtained and transmitted by Sensing Device 601. For example, Controller 602 may provide for music, videos, or any other form of entertainment within the room based on the data obtained and transmitted by Sensing Device 601. In another example, as illustrated in FIG. 9, Sensing Device 601 may compare the data indicating that a person has entered the room to data indicating that nobody is permitted to enter the room. Alternatively, the data may indicate that specific people are permitted within the room, and Sensing Device 601 or Controller 602 may determine that data identifying the person entering the room does not match identifying data indicating people who are permitted to enter the room. Based on this data in this example, Controller 603 may control Security System 901 to institute security measures, such as, but not limited to, activating Alarm 902 or Locking 903 windows or doors, to name a few.

In yet another example illustrated in FIG. 10, Sensing Device 601 may detect the presence of individuals within a room or space and may further determine a distance between the individuals. In this non-limiting example, two people are detected within a space and the distance between the two people is, for example, five feet. A predetermined rule that individuals are to maintain a particular distance from each other, such as a rule that individuals must maintain a distance of at least six feet from other individuals, may be in effect. In such a case, Sensing Device 601 may transmit data to Controller 602, the data indicating that at least two individuals within the room or space are situated less than six feet apart from each other. Controller 602 may receive the data transmitted from Sensing Device 601 and may provide a control signal to provide a reminder to the at least two individuals to maintain the desired distance from each other, in this non-limiting example, six feet. For example, based on the data received from Sensing Device 601, Controller 602 may provide a control signal to provide a reminder to appear on Monitor 1001 in the room, may provide an audio reminder on Intercom System 1003, or may provide the reminder to an individual's Personal Device 1002, such as a phone. It will be understood by those of skill in the art that any number or type of device may be used to provide the desired reminder to an individual.

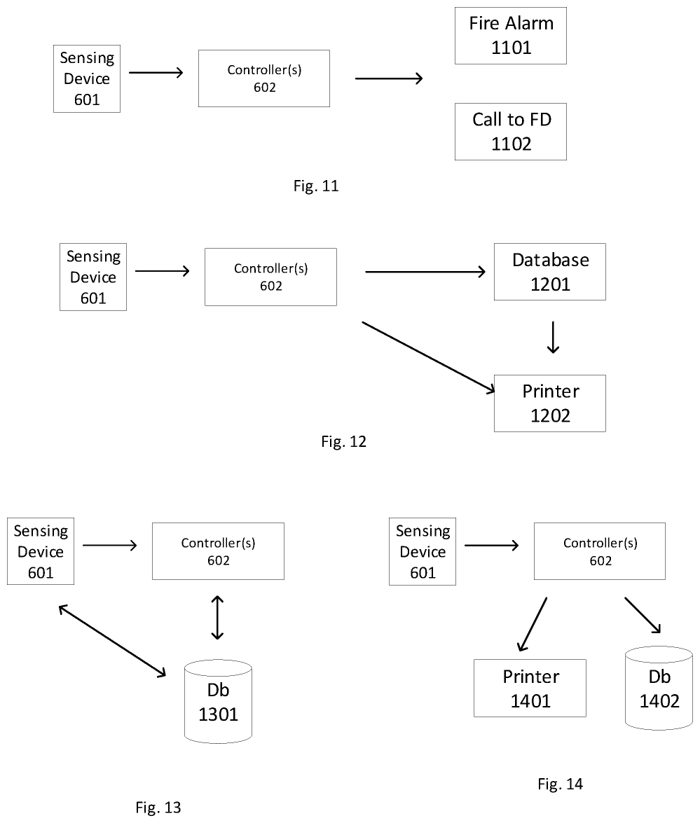

In yet another example, as illustrated in FIG. 11, Sensing Device 601 may detect the presence of smoke, fire, or another indicator of an emergency situation within a room. Sensing Device 601 may transmit such data to Controller 602, which may receive the data from Sensing Device 601 and provide a corresponding control signal in response to the data. In this non-limiting example, Controller 602 may provide a control signal to activate a Fire Alarm 1101 or Alert Fire Officials 1102 or any other pertinent officials of the situation and may further alert individuals within the room to vacate the premises, for example.

In another example illustrated in FIG. 12, Sensing Device 601 may collect data pertaining to the room and its use. For example, Sensing Device 601 may collect data pertaining to the number of people using the room over a specified period of time, the times or days the room is used most and least frequently, the extent as to which the room is used, etc. This data may be transmitted to Controller 602 or may be stored in Database 1201 for use in resource planning. For example, if a room is determined to have less usage at a particular time, day, or time of day, an event may be planned in the room with a level of assurance that the event being planned would not conflict with another regular occurring event in the room. A report may be printed on Printer 1202, displayed, or otherwise provided to the user.

In another example, if Sensing Device 601 finds that a room is not used at all during a day, Controller 602 may provide a report that that room may not need to be cleaned that day. In another example, if Sensing Device 601 finds that a room is only in use for a few minutes a day regularly, it may report that an HVAC system, lights, and other resources may be reduced for this room. Database 1201 may allow studies that allow room usage and resource usage to be optimized.

In another example, a control system may be taught to recognize members of a cleaning staff. Machine learning models may learn to recognize cleaning staff by equipment, uniform, or facial recognition, for example.

In another example, as illustrated in FIG. 13, Sensing Device 601 may collect data pertaining to the presence of individuals within the space or room, the space or room including a place of business, and the individual(s) including customers of the business. In this example, Sensing Device 601 may collect data, including profile data, pertaining to the individuals or customers in the place of business and may compare the collected profile data with data stored in Database 1301. For example, the collected data may include facial recognition data to identify the individual or customer in the place of business, and the stored data may include previous customers in the place of business. In this example, the system may determine if the current customer is a repeat customer or a new customer. If a match is not identified, then the current customer may be determined not to be a repeat customer, and the database may be updated to include a record of the current customer. If a match is identified, then the current customer may be determined to be a repeat customer, and the database may be updated to include the current visit by the repeat customer.

In addition, actions taken by the current customer may be identified by Sensing Device 601. Such data may include, for example, the customer's gait, silhouette, face size, facial features, sounds made by the customer (e.g., voice), skeletal scan, brain scan, estimated age, or any other relevant information including, for example, a QR code, an RFID code, a footprint scan, or a fingerprint scan, if obtainable. In addition, in a retail business environment or store, demographic data (e.g., age, gender, family status, residence data, job data) of the customer, data pertaining to various products, logos, or advertisements that may be experienced by the customer over a certain period of time, any of which may be accessed or stored in the database. The length of time the customer remains in the store or engages with store employees also may be noted and stored. Also, the time of day the customer visits the store, the form of payment used by the customer, the products declined by the customer, and the products ultimately purchased by the customer may also be recorded. These are merely examples of customer characteristics, activity, or behavior that may be recorded and is not meant to be an exhaustive list.

In another example, illustrated in FIG. 14, Sensing Device 601 may obtain information pertaining to a room or space and may transmit the data to Controller 602, for example. Controller 602 may store the data in Database 1402 such that the data may be accessed by individuals. In addition to or alternatively, the data may be provided in a report, which may be displayed on a monitor or printed on printer 1401, to individuals who desire such information. For example, individuals may desire such information to prove compliance with existing rules or may require such information to mitigate risks of undesired outcomes in the room or the environment in which the room exists.

A number of people entering and exiting a room may also be tracked. A model may be created to track objects entering or leaving a space. An area may be tracked to determine if an object is moving in or out of a room, for example. The model may be trained to recognize the top of a person's head and only count entries and exits of people, so that a box a person is carrying, or a dog accompanying a person, for example, would not be counted. Entering into or exiting a room may be determined by establishing a vector that a person's head has taken. A bounding box may be determined for a starting point of a vector, and a boundary box may be determined for the ending of the vector. If the vector started in a starting entry bounding box, and the vector ended in the entry ending bounding box, the movement may be counted as a person entering the room. Similarly, a person leaving the room may be determined by a vector for the person's head's movement.

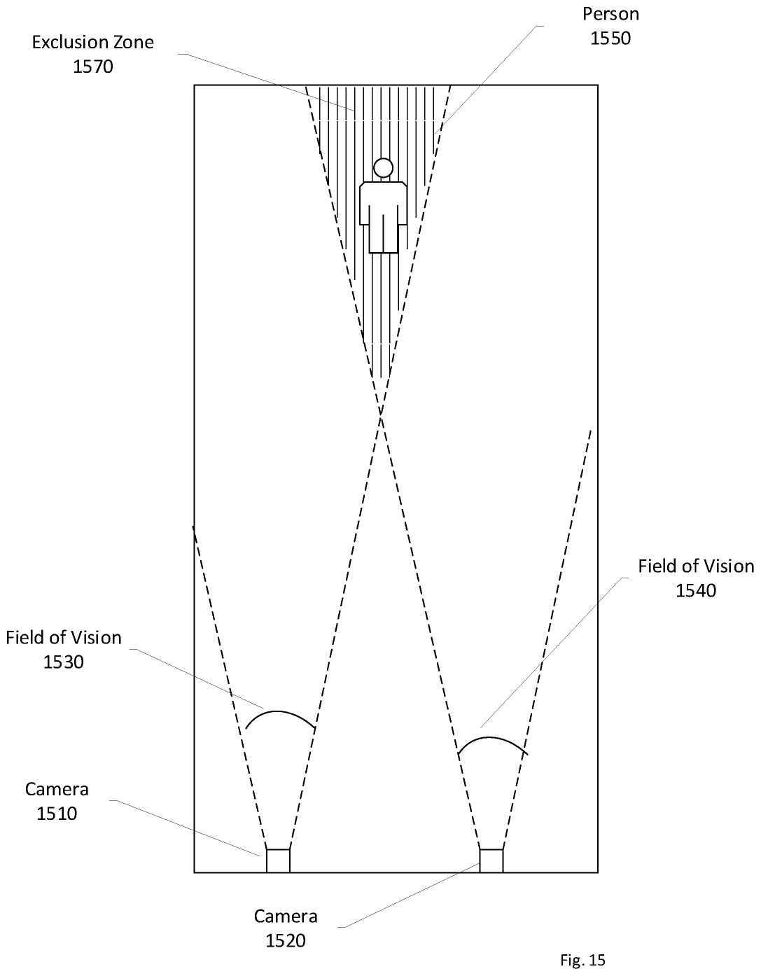

FIG. 15 illustrates Person 1550, who may be in a room in a position that would allow multiple cameras to detect them. Camera 1 510 may have a Field of Vision 1530, and Camera 1 520 may have a Field of Vision 1540, both of which may include Person 1550. Camera 1510 and Camera 1 520 may each count Person 1 550 as in the room, giving an inaccurate report of room usage.

Exclusion Zone 1 570 may be defined to exclude overlap of images from Camera 1520 and Camera 1520. Exclusion Zone 1 570 may be defined by one or more virtual boxes, triangles, or any shapes that block part of Field of Vision 1530 or 1540, which may prevent overlapping fields of vision from multiple cameras from counting a person or other item twice. This may prevent heating, cooling, or other resources from being overused because of a miscount of a room's contents.

While various aspects and embodiments have been disclosed herein, other aspects and embodiments will be apparent to those skilled in the art. The various aspects and embodiments disclosed herein are for purposes of illustration and are not intended to be limiting.

1. A method, comprising:
collecting data, wherein the data is associated with an environment, controlling a system based on the collected data, the system being associated with the environment.

2. The method of claim 1, wherein the data is collected by a sensing device.

3. The method of claim 2, wherein the data indicates a status of the environment.

4. The method of claim 3, wherein the controlling includes modifying the status of the environment.

5. The method of claim 4, wherein the data indicates a status selected from the group consisting of a presence of at least one individual within the environment, an absence of individuals within the environment, a number of individuals in the environment, and a relative positioning of individuals in the environment.

6. The method of claim 5, wherein the controlling includes at least one of controlling an HVAC system, controlling a security system, controlling lighting, controlling an alarm, and displaying information on a display.

7. The method of claim 6, wherein the data is stored in at least one of the sensing device, the controller, or a cloud.

8. The method of claim 7, wherein the data is provided to a user by at least one of displaying the data on a display or providing a written report.

9. The method of claim 7, wherein the data further includes data associated with an individual, the method further comprising:
comparing the data associated with the individual with a database of data to determine a match with data within the database; and
updating the database based on the comparing.

10. The method of claim 9, wherein the updating further includes adding the data associated with the individual to the database if a match is not identified; and
modifying the data associated with the individual within the database if a match is identified.

11. A system comprising:
a sensing device for collecting data pertaining to an environment; and
a controller for controlling a system based on the collected data.

12. The system of claim 11 wherein the system comprises at least one of an HVAC system, a security system, a fire safety system, a lighting system, a resource planning system, or a social distancing system.

13. The system of claim 12 wherein the system comprises an HVAC system, and the controller modifies an operation of the HVAC system based on the collected data.

14. The system of claim 13 wherein the collected data indicates at least one of a number of individuals or a density of individuals within the environment.

15. The system of claim 14 wherein the collected data is compared to stored data to determine if the collected data exceeds a threshold value and if the collected data exceeds the threshold value, modifying the operation of the HVAC system.

16. The system of claim 15 wherein the operation of the HVAC system is not modified if the collected data does not exceed the threshold value.

17. A method for monitoring a customer experience, comprising:
collecting profile data for a customer;
comparing the profile data with a database of customers and using the comparison to determine that:
the customer matches a record in the database and is a repeat customer; or
the customer does not match any record in the database and is a new customer;
if the customer is determined to be a repeat customer, updating the database to add a current visit to the matched record;
if the customer is determined to be a new customer, adding a record of the customer to the database; and
recording at least one feature of the experience of the customer in the database and associating the recorded feature with the customer.

18. The method of claim 17, wherein the recorded feature is selected from the group consisting of products shown to the customer, products purchased by the customer, identity of employee serving customer, number of employees serving customer, duration of customer visit, time of customer visit, location of customer visit, method of payment used by the customer, customer sentiment, employee sentiment, logos viewed by customer, and scenes viewed by the customer.

19. The method of claim 18, wherein collecting profile data for a customer includes determining demographic data for the customer.

20. The method of claim 18, wherein using the comparison includes determining a probability that the customer may match a record in the database and may be a repeat customer.
